(19) United States
(12) Patent Application Publication
(10) Pub. No.: US 2025/0370804 A1
(43) Pub. Date: Dec. 4, 2025

(54) ARTIFICIAL INTELLIGENCE-DRIVEN SYSTEM MEMORY DUMP CAPTURE

(71) Applicant: International Business Machines Corporation, Armonk, NY (US)

(72) Inventors: Andrew C. M. HICKS, Highland, NY (US); Michael E. GILDEIN, Wappingers Falls, NY (US); Michael Terrence COHOON, Fishkill, NY (US)

(21) Appl. No.: 18/679,540

(22) Filed: May 31, 2024

(51) Int. Cl. G06F 9/50

(52) U.S. Cl. CPC G06F 9/5022

(57) ABSTRACT

Method and apparatus for predictive dump capture are provided. A prediction indicating that a failure within a computing system will occur at an anticipated time is received. One or more existing processes are assessed over a time window to identify data for preservation, wherein the time window begins at the reception of the prediction and extends to the anticipated time of the failure. Workloads of the computing system are quiesced based on the assessment. A memory dump process is initiated to save data in memory of the computing system. Backup resources are searched to expedite the memory dump process.

### BACKGROUND

The present disclosure relates to system memory dump capture and, more specifically, to managing and optimizing the memory dump capture process based on predictive system failures.

In complex computer systems, the use of resources and system activities is primarily driven by demanding applications, user transactions, and data processing. When errors or failures occur in these systems, the process of debugging and determining the problem becomes challenging. Successful root cause analysis often depends on having access to complete data at the time of the failure, which is stored in a register or frame within memory. Without this data, it can be significantly more difficult to conclusively determine the original cause of the failure.

### SUMMARY

One embodiment presented in this disclosure provides a method, including receiving a prediction indicating that a failure within a computing system is predicted to occur at an anticipated time, assessing one or more existing processes over a time window to identify data for preservation, where the time window begins at the reception of the prediction and extends to the anticipated time of the failure, quiescing workloads of the computing system based on the assessment, initiating a memory dump process to save data in memory of the computing system, and searching backup resources to expedite the memory dump process.

Other embodiments in this disclosure provide non-transitory computer-readable mediums containing computer program code that, when executed by operation of one or more computer processors, performs operations in accordance with one or more of the above methods, as well as systems comprising one or more computer processors and one or more memories containing one or more programs that, when executed by the one or more computer processors, perform an operation in accordance with one or more of the above methods.

### BRIEF DESCRIPTION OF THE DRAWINGS

FIG. 1 depicts an example computing environment for the execution of at least some of the computer code involved in performing the inventive methods.

FIG. 2 depicts an example architecture of a distributed system utilizing one embodiment of the present disclosure.

FIG. 3 depicts an example of a workflow for preserving system state in response to a predictive failure, according to some embodiments of the present disclosure.

FIG. 4 depicts an example method for managing memory capture based on a predictive failure, according to some embodiments of the present disclosure.

FIG. 5 is a flow diagram depicting an example method for artificial intelligence (AI)-driven system dump capture, according to some embodiments of the present disclosure.

FIG. 6 depicts an example computing device configured to perform various aspects of the present disclosure, according to some embodiments of the present disclosure.

### DETAILED DESCRIPTION

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In complex computer systems, resource usage and system activity are primarily driven by demanding applications, data processing tasks, and user transactions. When an error or failure occurs, debugging and problem determination are relied upon to quickly restore system functionality. To accurately identify the problem, engineers may review documents that capture the system's memory state at the time of failure. However, such backups often fail due to constraints in processing resources, a lack of predictive knowledge, or operational disruptions, making the debugging process more challenging.

Embodiments of the present disclosure provide techniques and methods for initiating memory dump operations to capture a computing system's state data before a failure actually occurs, based on a predictive alert. The predictive alert may indicate when a disastrous failure is likely to occur in a computer system. In some embodiments, these predictions may be generated by machine learning (ML) models that analyze historical datasets and ongoing system metrics to identify patterns or anomalies that indicate a potential failure. Upon receiving the prediction, the computer system initiates a memory dump process, which captures the system's state until the failure actually occurs. The data captured may then be used for debugging and/or identifying the root cause of the failure. In some embodiments, in addition to initiating the memory dump process, the method may further include performing a series of additional actions designed to maintain the data integrity and/or the system's functionality, such as quiescing workloads, disabling paging of existing address spaces or processes, and provisioning backup resources to expedite the dump data capture.

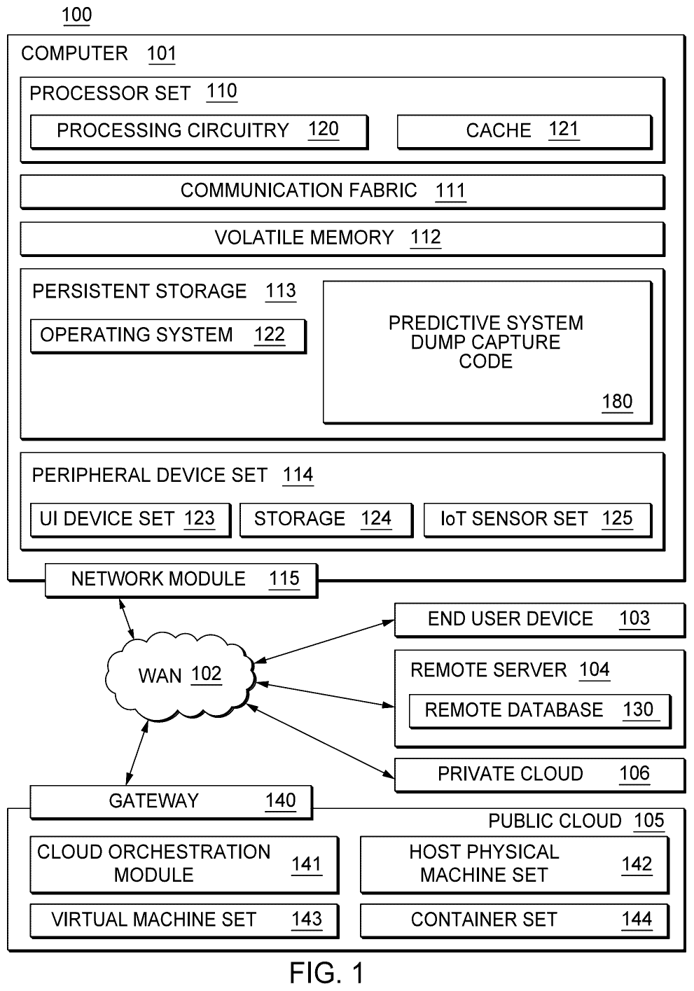

FIG. 1 depicts an example computing environment 100 for the execution of at least some of the computer code involved in performing the inventive methods.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as Predictive System Dump Capture Code 180. In addition to Predictive System Dump Capture Code 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and Predictive System Dump Capture Code 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in Predictive System Dump Capture Code 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in Predictive System Dump Capture Code 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

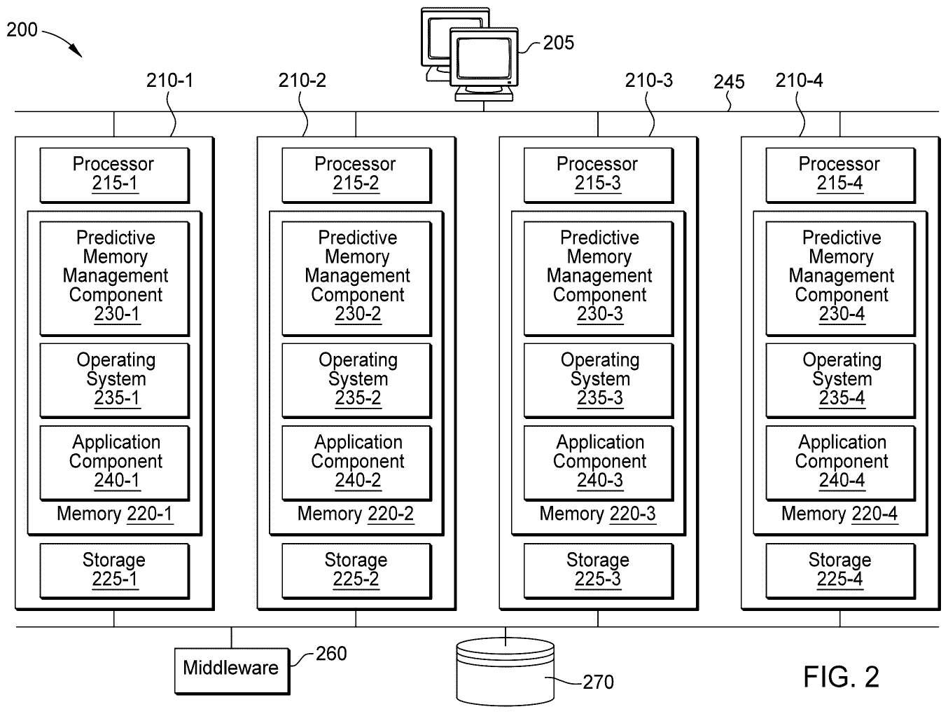

FIG. 2 depicts an example architecture of a distributed system 200 utilizing one embodiment of the present disclosure. In the illustrated example, the system 200 includes one or more client devices 205 communicatively coupled to a cluster of server nodes 210-1, 210-2, 210-3, and 210-4, and one or more databases 270.

In the illustrated example, the distributed system 200 includes four nodes, with nodes 210-1, 210-2, and 210-3 running different computing systems that provide various applications and services. These nodes 210 may be designed to handle different operational loads and tasks. Node 210-4 is primarily used as backup resources to provide redundancy, and ensure system reliability when hardware failure or maintenance occurs on the primary nodes (including nodes 210-1, 210-2, and 210-3).

In the illustrated example, the client device 205 represents an entry point into the distributed system 200, and functions as a central control hub. The client device 205 can be any computing device capable of communicating with one or more nodes 210-1, 210-2, 210-3, and 210-4 within the system. In some embodiments, the client devices 205 may monitor the operations of each node to detect errors or anomalies, and access overall system health. In some embodiments, the client device 205 may correspond to any conventional computing device, such as laptops, desktops, tablets, and smart phones. In some embodiments, the client device 205 may correspond to a specialized device, such as Internet-of-Things (IoT) sensors, embedded systems, and network applications, provided that they have the necessary software and network capabilities to interface with the distributed system. In some embodiments, the client device 205 may include one or more CPUs, one or more memories, one or more storages, one or more network interfaces, and one or more input/output (I/O) interfaces, where the CPU may retrieve and execute programming instructions stored in the memory, as well as store and retrieve application data residing in the storage.

In some embodiments, the client device 205 may monitor the computing environment on each node 210, and collect a wide range of data that indicate the system's health and performance. The client device 205 may then aggregate the data from each node for error and failure prediction.

In some embodiments, the client device 205 may include a failure prediction engine that utilizes machine learning (ML) techniques to analyze the collected data. The engine may identify unusual patterns and/or anomalies that deviate from normal operation baselines. The patterns or anomalies may include CPU spikes, memory leaks, extended response times, or other characteristics that may indicate underlying issues or errors. In some embodiments, the engine may assess the likelihood of a potential failure based on the anomalies and/or patterns detected. The engine may assign a measure of confidence to its predictions, indicating the reliability of the predictions. When the confidence level exceeds a defined threshold, the engine may generate predictive alerts for impending disastrous failure. In some embodiments, the alerts may specify the affected nodes 210, the nature (or type) of the potential failure, an estimated time at which the failure is expected to occur, and the like. Upon generation, in some embodiments, the client device 205 may send the alerts to the affected nodes 210 for immediate actions.

As illustrated, the client device 205 connects to the nodes 210 through network connections 245, which enable communication and interaction between these devices. Through the network connections 245, each node 210 may report data reflecting its computing environment to the client device 205 for error and/or failure prediction. Additionally, the network connections 245 allow the client device 205 to send predictive alerts and/or operational commands back to nodes 210.

In the illustrated example, upon receiving these alerts, each node 210 may conduct one or more proactive steps to mitigate the impact of the predicted failure and save necessary data for debugging purposes. These actions may include, but are not limited to, quiescing the system's existing workloads, disabling the operating system or existing processes (or address spaces) from paging, initiating a memory dump to preserve the current state of the system, searching (and/or provisioning) backup resources and, if available, rerouting traffic and workloads to the backup resources.

In the illustrated example, each node (e.g., 210-1) comprises three components: one or more processors (e.g., 215-1), one or more memory units (e.g., 220-1), and one or more storage units (e.g., 225-1). In some embodiments, the memory may be any type of volatile memory, such as dynamic random access memory (RAM) or static RAM. As illustrated, the memory (e.g., 220-1) serves as the temporary storage medium for the active execution of various components within the node. During runtime, the processor (e.g., 215-1) may access and execute the programming instructions stored in the memory (e.g., 220-1), as well as store and retrieve application data residing in the storage (e.g., 225-1). In the illustrated example, since nodes 210-1, 210-2, and 210-3 are actively operating to provide services to demanding applications, the memory 220 of these nodes contains the application components 240 and the operating system 235.

In some embodiments, the application component (e.g., 240-1) may contain the software (e.g., program codes) that provides the primary functionalities or services that the node is designed to offer. The application component (e.g., 240-1) may be configured to process input/output data, handle primary tasks, and manage interactions with other components within the distributed system (e.g., other nodes 210, client devices 205). The application component (e.g., 240-1) may ensure that the node provides the intended service to users or other components.

In some embodiments, the operating system (e.g., 235-1) may contain program codes that facilitate the normal operations of a computing system, including scheduling tasks, managing memory access, and monitoring the execution of application programs. In some embodiments, the operating system (e.g., 235-1) may provide services such as resource allocation, system security, process management, and device control. These service may enable applications to perform optimally and securely within the specific hardware environment.

Upon receiving an alert from the client device 205 that indicates an imminent disastrous failure, in the illustrated example, the predictive memory management (PMM) component (e.g., 230-1) is loaded from the storage (e.g., 225-1) into the memory (e.g., 220-1) on the affected node (or computing system) (e.g., 210-1). In some embodiments, the PMM component 230 may include program codes specifically designed to manage the process of system state preservation. The PMM component 230 may initiate a series of proactive actions to capture the system's memory state before a potential failure occurs. These actions may include, but are not limited to, quiescing current operations to prevent data corruption, disabling the operating system or existing processes (or address spaces) from paging, starting a memory dump to preserve the current state of the system, searching (and/or provisioning) backup resources (e.g., node 210-4) and, if available, rerouting traffic and workloads to the backup resources. These proactive actions may ensure that valuable data for post-failure debugging and/or root cause analysis is preserved. After a failure occurs, engineers may use the preserved data to quickly identify the causes of the issue, and/or restore functionality of the computing system on the affected node 210.

In the illustrated example, node 201-4 serves as backup resources for primary nodes 210-1, 210-2, and 210-3, with its memory 220-4 remaining unused under normal operations. Upon receiving an alert indicating a potential system failure, the PMM component 230 on the affected node (e.g., node 210-1) may search for backup resources that can be used to maintain system operations without interruption. In some embodiments, the PMM component 230 may conduct a scan of the system topology to determine the availability of backup resources. In some embodiments, the PMM component 230 may consult a defined user-policy that specifics which backup resources to use in response to different types of failures.

In some embodiments, upon detecting that node 201-4 is available for use, the PMM component 230 (on the affected node(s)) may then redirect traffic and operational loads to node 210-4. In parallel with the reroute, the PMM component may initiate memory dump operations on the affected node(s). By redirecting the traffic and operational loads to node 210-4, the computing system on the affected node(s) may continue to function without downtime. Therefore, the redirection guarantees end users receive uninterrupted service even if a node fails. Additionally, the redirection may effectively offload the demand from the affected node(s) (e.g., nodes 210-1, 210-2, and 210-3), allowing the potentially failing node to focus on the memory dump process. For example, the affected node(s) may allocate more system resources (e.g., CPU cycles, memory access) directly to the memory dump process, and therefore speed up the data capture and storage. The reduction in operational load during the memory dump may also help in capturing a more accurate state of the system during the dump from the time of receiving the prediction to the time the failure occurs (or is expected to occur). With fewer changes in the system's state, the data captured of the memory may more accurately reflect the conditions that may have led to the predicted failure.

In some embodiments, only the memory 220-4 of node 210-4 is available for backup use, while other resources (e.g., CPU, I/O interfaces, network interfaces) are engaged in other tasks or processes. In such configurations, the PMM component 230 may utilize the available memory 220-4 for additional processing needs of the system, such as providing uninterrupted services to end users. This approach allows the failing node to maintain continuous operations by utilizing unused memory resources, without disrupting the data for failure analysis on the existing memory. The PPM component 230 may continue to monitor the system's state, and initiate a memory dump on the failing node.

In embodiments where backup resources such as conventional disaster recovery (DR) resources have already been provisioned, the PMM component 230 may quiesce the affected computing system to stabilize its state and minimize the risk of data corruption. Following the system quiescence, the PMM component 230 may activate the DR site and execute a failover (e.g., moving the operational loads to the DR site). In some embodiments, the DR site may include alternative hardware (or virtual) resources and be configured to take over the full functionalities of the affected system. The failover allows normal operations to continue with minimal disruption. When the failover to the DR site is completed (and/or it is verified that the DR site is fully operational), the PMM component 230 may initiate a memory dump on the original failing node.

In the illustrated example, the nodes 210-1, 210-2, 210-3, and 210-4 in the distributed system 200 can be any type of computing device, ranging from traditional servers in a data center to cloud-based virtual machines, hypervisors, edge devices, and/or workstations. These nodes 210-1, 210-2, 210-3, and 210-4 may cooperate with each other to provide a seamless service to end users.

In embodiments where the node 210 acts as a hypervisor, managing multiple virtual machines (VMs) that run on its physical hardware with different computing systems operating on separate VMs, the node (or the hypervisor) may correlate each VM's workloads with their respective physical resource partitions. When the PMM component 230 detects or receives a prediction of a potential failure, it may identify which VMs (or physical partitions of resources) are likely to be affected based on the nature of the predicted issue. For example, if the failure involves an application crashing, the PMM component 230 may precisely identify which VMs (or physical partitions of resources) are running this application. Upon determining the VMs (or physical partitions of resources) of interests, the PMM component 230 may initiate a memory dump specifically for those affected VMs (or physical partitions of resources), leaving other VMs operating normally.

In the illustrated example, the nodes 210-1, 210-2, 210-3, and 210-4 connect to one or more databases 270 and/or middleware 260 via network connections 250. In some embodiments, the network connections 245 and 250 may include or correspond to a wide area network (WAN), a local area network (LAN), the Internet, an intranet, or any combination of suitable communication mediums that may be available, and may include wired, wireless, or a combination of wired and wireless links. The network connections 245 and 250 may provide connectivity for the various systems, components, or resources within the distributed system 200, and may be implemented using protocols such as Transmission Control Protocol (TCP) and/or Internet Protocol (IP). In some embodiments, the client devices 205, the nodes 210, the databases 270, and the middleware 260 may be local to each other (e.g., within the same local network and/or the same hardware system), and communicate with one another using any appropriate local communication medium, such as a local area network (LAN) (including a wireless local area network (WLAN)), hardwire, wireless link, or intranet, etc. In some embodiments, one or more of the client devices 205, the nodes 210, the databases 270, and the middleware 260 may be remote from each other (e.g., located in different geographical locations), and communicate with one another using any appropriate communication medium, such as a wide area network (WAN) or the Internet.

In some embodiments, the predicted failure may include various types, such as system crash, an outage, a significant degradation of performance, or other incidents that disrupt normal operations of a computing system. The PMM component 230 may provision backup resources based on the specific type of predicted failure. For example, when an imminent outage is predicted, the PMM component 230 may search for persistent, non-volatile storage, such as hard disk drives (HDDs), solid state drives (SDDs), USB flash drives, or even network storage devices. Data written to the non-volatile storage may persist even if the system power is disrupted. Data operations are conducted on both volatile memory and non-volatile storage. Volatile memory offers high-speed data access and processing capabilities, while non-volatile storage provides a durable medium for long-term data storage. When the PMM component 230 initiates the memory dump process, it captures the data currently in memory 220 for non-volatile storage, which includes all active processes and system state information from the time of the failure prediction extending to the time of the failure occurrence (or expected occurrence). In parallel, data is written on non-volatile storage. If the system fails before the memory dump process is complete, the data written on the non-volatile storage may serve as a reliable backup for recovery and analysis.

The illustrated distributed system 200 that includes four nodes 210 is depicted for conceptual clarity. In some embodiments, the distributed system 200 may include any number of nodes 210 that operate different computing systems or host various applications and services.

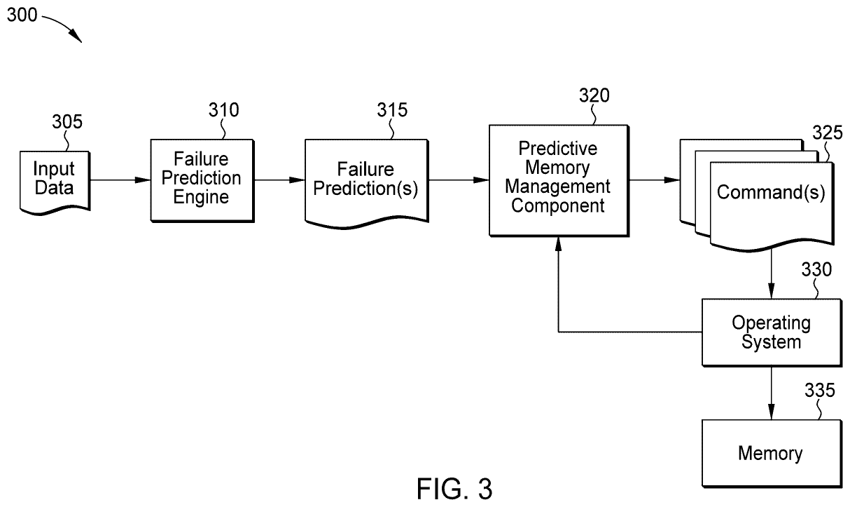

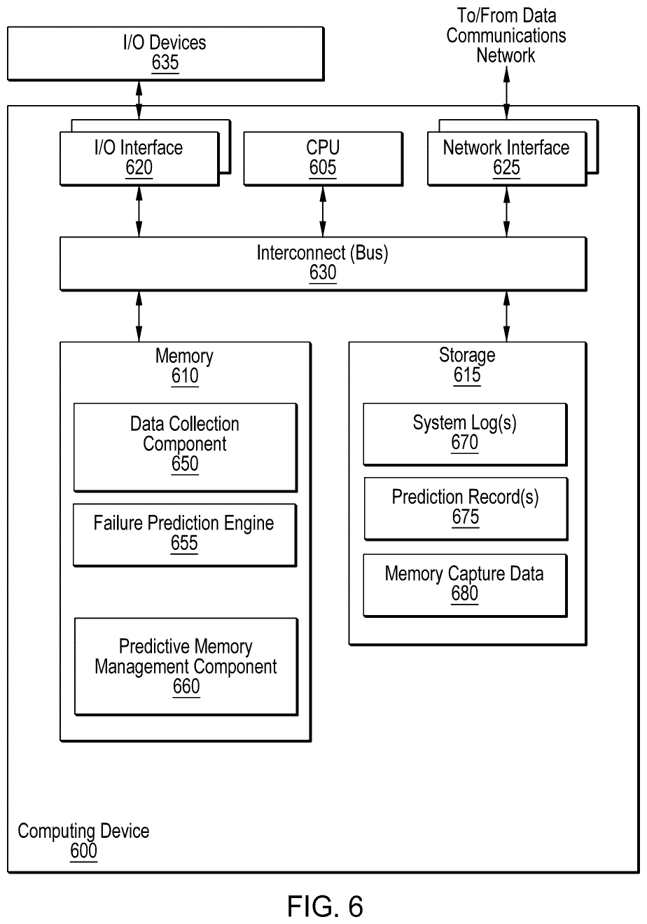

FIG. 3 depicts an example of a workflow 300 for preserving system state in response to a predictive failure, according to some embodiments of the present disclosure. In some embodiments, the workflow 300 may be performed by one or more computing systems, such as the computer 101 as illustrated in FIG. 1, the client device 205 or the server node 210 as illustrated in FIG. 2, and/or the computing device 600 as illustrated in FIG. 6.

In the illustrated example workflow 300, input data 305 is provided to the failure prediction engine 310, which is configured to monitor the health of computing systems operating on different server nodes (e.g., 210 of FIG. 2) or VMs. The input data 305 may include a variety of metrics that indicate the performance or stability of each computing system. These metrics may include CPU usage, memory utilization, I/O operations, network traffic, error rates, and the like. By analyzing these inputs, the failure prediction engine 310 may identify patterns and/or anomalies that deviate from normal operational baselines. In some embodiments, these anomalies may include CPU spikes, memory leaks, unusual high I/O operations, extended response times, or other characteristics that indicate underlying issues. In some embodiments, the failure prediction engine 310 may use the input data 305 to build its predictive models. Utilizing ML techniques, the failure prediction engine 310 may iteratively refine its predictive models using historical data patterns and ongoing system metrics. Through iterative learning, the failure prediction engine 310 may predict potential failures and/or estimate their likely timing. In some embodiments, the failure prediction engine 310 may generate a measure of confidence for each prediction. The confidence measure may indicate the reliability of each prediction (such as the likelihood that the predicted failure may occur). When the confidence level exceeds a predefined threshold, indicating the predicted failure is very likely to occur, the failure prediction engine may send the prediction 315 to the affected computing system. The prediction 315 may detail the affected resources (e.g., CPU, memory), the nature (or type) of the failure (e.g., an outage, a system crash, or a significant degradation of performance that disrupts normal operations), and an estimated time when the failure is expected to occur.

Upon receiving the failure prediction 315, the affected computing system activates its predictive memory management (PMM) component 320 (which may correspond to the PMM component 230 as depicted in FIG. 2) by loading the component from its storage (e.g., 225 of FIG. 2) into active memory (e.g., 220 of FIG. 2). Once activated, the PMM component may assess the prediction details, including the nature (or type) of the predicted failure (e.g., an outage, a system crash, a significant degradation of performance), the affected resources (e.g., CPU, memory, storage, I/O interfaces, network interfaces), and the expected timing. Based on the assessment, the PMM component 320 may initiate proactive actions to stabilize the system, and preserve necessary memory data for debugging and/or root cause analysis. These actions may include quiescing workloads on the computing system, disabling paging for the operating system and certain existing processes (or address spaces), initiating a memory dump process (e.g., standalone dump), and searching (and/or provisioning) backup resources based on the type of the predicted failure.

To implement these proactive actions, the PMM component 320 may send one or more commands 325 to the operating system 330, which manages hardware resources and exercises control over system processes. As used herein, quiescing workloads or operations of the affected computing system may involve temporarily halting or reducing the activity on the system, which may include, but are not limited to, stopping new transactions, pausing scheduled tasks, or limiting user access. By reducing system's activities, the PMM component 320 may stabilize the computing system as much as possible to preserve the conditions that could potentially lead to the predicted failure.

As used herein, paging is a memory management mechanism that eliminates the need for a program to fit entirely into physical memory. Disabling paging for the operating system and/or specific existing processes (or address spaces) refers to a situation where the data for the operation system and existing processes will be retained in the physical memory (e.g., 220 of FIG. 2), rather than being swapped out to disk (e.g., 225 of FIG. 2). The benefit of this action to keep valuable diagnostic information in physical memory, and ensure that the data is not lost due to overwriting or paging out. In some embodiments, selective paging may be implemented, which involves keeping existing processes (or address spaces) (that occurred before receiving the prediction) in physical memory while permitting new processes (or address spaces) (that occur after receiving the prediction) to use paging. The selective paging strategy may preserve necessary information for debugging without completely halting the affected computing system's operations.

As used herein, a memory dump process involves collecting and storing the contents of the system's memory 335. In some embodiments, a standalone dump may refer to a process that captures memory data independently of the main operating system to ensure data integrity. The memory dump process may be initiated by the PMM component 320 at the time of receiving the prediction 315 until the failure occurs (or is expected to occur). The captured memory state may be saved into non-volatile storage (e.g., HDDs, SSDs, USB drives, network storage devices) for post-failure debugging and/or root cause analysis.

As used herein, searching backup resources may refer to the process of identifying alternative hardware (or virtual) resources (e.g., CPU, memory, storage, I/O interfaces, and network interfaces) to support system functions while the primary resources are conducting a memory dump. As used herein, provisioning backup resources may refer to the process of setting up and configuring these backup resources according to a predefined disaster recovery plane or user policy, to ensure these resources are ready to be activated upon receiving a notice. As discussed above, in some embodiments, the backup resources may be identified through a system topology scan. The scan may help to map out the available hardware or virtual resources across the network. In some embodiments, the backup resources may be identified by consulting a defined policy, which specifies the resources that can be used in response to a specific failure.

In some embodiments, such as when the backup resources (e.g., node 210-4 of FIG. 2) are available, the PMM component 320 may instruct the operating system 330 to redirect traffic and operational loads to these resources. The redirection may enable the affected system to continue normal operations and provide services for end users without disruption. In parallel with the redirection, the primary resources, now relieved of their normal operational loads, may initiate a memory dump process to capture the system's state data. In embodiments where only unused memory (e.g., 220-4 of FIG. 2) is available, without other resources (e.g., CPU, storage) being free, the PMM component 320 may instruct the operating system 330 to utilize the unused memory for new processes, providing uninterrupted service to end users while keeping the original memory's contents unchanged. The PMM component 320 may then initiate memory dump operations on the original memory to ensure a record of the system's state at the time of failure. In embodiments where backup resources such as conventional disaster recovery (DR) architectures have already been provisioned, the PMM component 320 may activate the reserved DR site and execute a failover. Before or during the failover, the system may be quiesced to minimize changes. Upon completing the failover, a memory dump process may be initiated on the primary resources.

The memory dump operations may begin from the time the prediction 315 is received and continue until the failure actually occurs (or is predicted to occur). As illustrated, throughout the period, the operating system 330 may maintain communications with the PMM component 320, such as sending regular status reports. The ongoing communications may enable the PMM component 320 to continuously monitor the progress of the memory dump process and/or manage any conditions that may affect the predicted failure.

In some embodiments, the failure prediction engine 310 and the PMM component 320 may reside within the same computing device (e.g., server node 210 of FIG. 2), where the device monitors its local environment, including the operating system and/or applications operating on the specific server node. In some embodiments, the failure prediction engine 310 may be centralized to monitor several computing systems across different nodes or resources. As illustrated in FIG. 2, the failure prediction engine may reside on the client device 205 of a distributed system, while the PMM component may reside within each server node 210.

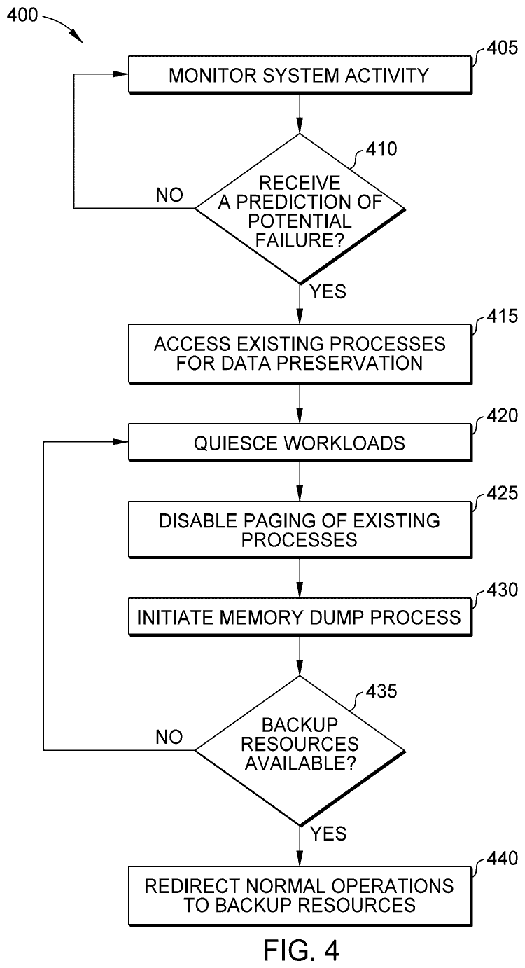

FIG. 4 depicts an example method 400 for managing memory capture based on a predictive failure, according to some embodiments of the present disclosure. In some embodiments, the method 400 may be performed by one or more computing devices, such as the computer 101 as illustrated in FIG. 1, the client device 205 or the server node 210 as illustrated in FIG. 2, and/or the computing device 600 as illustrated in FIG. 6.

The method 400 begins at block 405, where a computing device (e.g., server node 210 of FIG. 2) monitors its own system activity and sends the data to a central control hub (e.g., client device 205 of FIG. 2) for the analysis of potential issues. In some embodiments, the data may include system logs and/or operational parameters indicative of the system's performance or stability, such as CPU usage, memory utilization, I/O operations, network traffic, and error rates.

At block 410, the computing device determines whether a prediction of potential failure is received. If such a prediction is received (from the central control hub that detects potential failure patterns), the method 400 proceeds to block 415. If no prediction is received, the method 400 returns to block 405, where the computing device continues to monitor system activities and/or reports back to the central control hub. In some embodiments, the predicted failure may include various types, including but not limited to, a system crash, an outage, or a significant degradation of performance that disrupts the normal operations of the system.

At block 415, the computing device, upon receiving the prediction, evaluates its existing processes (or address spaces) to determine which data should be preserved for post-failure debugging and/or root cause analysis. The assessment may be conducted within a defined time window that begins at the moment the prediction is received and extends to the anticipated time of failure (or until the failure actually occurs). During the assessment, the device may evaluate which processes (or address space) contain operational data, system logs, and error messages that may indicate the cause of the imminent failure. In some embodiments, data involved in recent changes and anomalies in performance metrics may be given high priority. In some embodiments, based on the type of predicted failure, certain areas or processes may be flagged by the prediction engine as potential failure points, and should be given higher priority than others.

At block 420, the computing device, based on the assessment, quiesces its operational loads. In some embodiments, the quiescence may include temporarily halting or reducing the operations on the device, such as stopping new transactions, pausing scheduled tasks, or limiting user access. The operation is conducted to stabilize the device's environment and prepare for a memory capture.

At block 425, the computing system disables paging for the operating system and certain existing processes (or address spaces) (that occur before receiving the prediction and/or are considered important for root cause analysis) to keep their data in physical memory. The disabling operation may ensure that valuable diagnostic data is not swapped out to disk and remains accessible for memory capture. In some embodiments, selective paging may be implemented, which allows new processes (or address spaces) to continue using paging. The selective paging strategy maintains system stability by preserving valuable diagnostic data while still allowing the system to provide continuous service to end users through new processes.

At block 430, the computing device initiates a memory dump to capture the current state of the system's memory (e.g., 220 of FIG. 2). The memory dump process may capture all operational data and process information from the time of receiving the prediction to the time the failure actually occurs (or is predicted to occur).

At block 435, the computing device searches for backup resources. In some embodiments, the search may involve scanning the device's topology to identify unused or available resources that can be utilized as backups. In some embodiments, the device may examine a predefined user policy that specifies which resources are allocated for backup in response to different types of failures. If the device identifies available backup resources, the method 400 proceeds to block 440. If no backup resources are found, the method 400 returns to block 420, where the device maintains quiesced operations, and continues the memory dump process. The action ensures that the system remains in a stable state while preserving memory data for future diagnosis. In some embodiments, backup resources such as conventional DR architectures may have already been provisioned. In such a configuration, the computing device may activate the DR site and execute a failover. As used herein, a DR site may exist as part of a separate distributed system, designed for operation continuity in the event of a major system failure or disaster. The site may comprise the required hardware, software, and support infrastructure to handle all necessary operations of the original system independently. During the failover, the computing device may continue to quiesce the workloads to minimize any changes. Once the failover is complete (and/or it is verified that the DR site is operating normally), a memory dump is initiated on the original device to preserve the system state data.

At block 440, the computing device, upon determining that backup resources are available, redirects traffic and operational loads to these resources. Utilizing the redirection, the computing device now utilizes the backup resources to handle primary tasks and/or provide services to end users without disruption. Additionally, with the operational loads shifted, the active processing demands on the original device (the one experiencing potential failure) are significantly reduced, leaving the memory dump operations to be processed more quickly. In some embodiments, the backup resources may consist solely of unused memory, with other resources (e.g., CPU, storage) being engaged in other tasks or operations. In such configurations, the device may utilize the backup memory to accommodate new processes (that are initiated after the failure prediction has been received in response to ongoing user request), leaving the original memory unchanged. The device may then start memory dump operations on the original memory to capture the system state data at the time of failure.

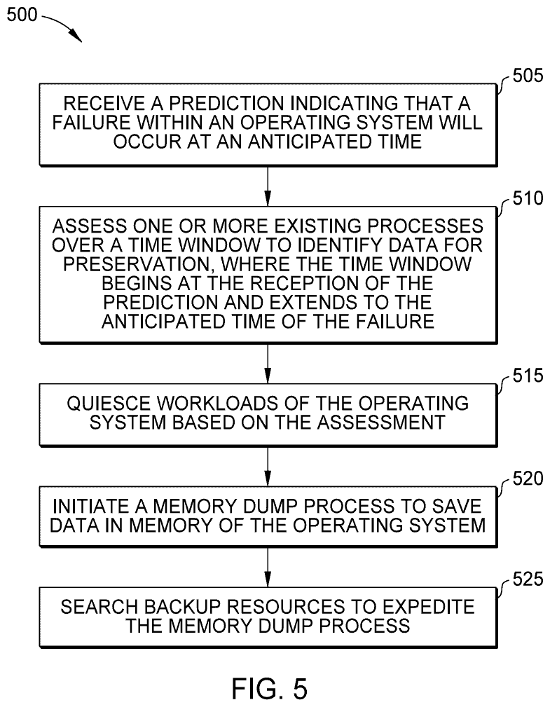

FIG. 5 is a flow diagram depicting an example method 500 for AI-driven system dump capture, according to some embodiments of the present disclosure.

At block 505, a computing device (e.g., serve node 210 of FIG. 2) receives a prediction (e.g., 315 of FIG. 3) indicating that a failure within a computing system will occur at an anticipated time.

At block 510, the computing device accesses one or more existing processes over a time window to identify data for preservation (as depicted at block 415 of FIG. 4), where the time window begins at the reception of the prediction and extends to the anticipated time of the failure.

At block 515, the computing device quiesces workloads of the computing system based on the assessment (as depicted at block 420 of FIG. 4).

At block 520, the computing device initiates a memory dump process to save data in memory of the computing system (as depicted at block 430 of FIG. 4). In some embodiments, the data saved during the memory dump process may capture a state of the one or more existing processes at the anticipated time

At block 525, the computing device searches backup resources to expedite the memory dump process (as depicted at block 435 of FIG. 4).

In some embodiments, the computing device may further disable paging of the one or more existing processes, and allow paging of one or more new processes that are initiated after the reception of the prediction.

In some embodiments, the failure within the computing system may comprise at least one of a system crash, an outage, or a performance degradation.

In some embodiments, the computing device may further organize the data saved during the memory dump process into structured documentation for debug analysis.

In some embodiments, the process of searching the backup resources may comprise performing a system topology scanning of the computing system to identify the backup resources.

In some embodiments, the process of searching the backup resources may comprise examining a defined policy that specifies the backup resources to be used in response to the failure.

In some embodiments, upon determining that the backup resources are available for use, the computing device may provision the backup resources to maintain normal operations of the computing system, and conduct the memory dump process on primary resources of the computing system.

In some embodiments, upon determining that unused memory within the backup resources is available for use, the computing device may allocate the unused memory from the backup resources for one or more new processes that are initiated after the reception of the prediction.

In some embodiments, upon determining that the backup resources have already been provisioned, the computing device may perform a failover operation that moves normal operations of the computing system to a disaster recovery site, and conduct the memory dump process upon completion of the failover.

FIG. 6 depicts an example computing device 600 configured to perform various aspects of the present disclosure, according to some embodiments of the present disclosure. The computing device 600 can be embodied as any computing device, such as the computer 101 as illustrated in FIG. 1, the client device 205 and/or the node device 210 as illustrated in FIG. 2.

As illustrated, the computing device 600 includes a CPU 605, memory 610, storage 615, one or more network interfaces 625, and one or more I/O interfaces 620. In the illustrated embodiment, the CPU 605 retrieves and executes programming instructions stored in memory 610, as well as stores and retrieves application data residing in storage 615. The CPU 605 is generally representative of a single CPU and/or GPU, multiple CPUs and/or GPUs, a single CPU and/or GPU having multiple processing cores, and the like. The memory 610 is generally included to be representative of a random access memory. Storage 615 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 635 (such as keyboards, monitors, etc.) are connected via the I/O interface(s) 620. Further, via the network interface 625, the computing device 600 can be communicatively coupled with one or more other devices and components (e.g., via a network, which may include the Internet, local network(s), and the like). As illustrated, the CPU 605, memory 610, storage 615, network interface(s) 625, and I/O interface(s) 620 are communicatively coupled by one or more buses 630.

In the illustrated embodiment, the memory 610 includes a system monitoring component 650, a failure prediction engine 655, and a predictive memory management (PMM) component 660. Although depicted as a discrete component for conceptual clarity, in some embodiments, the operations of the depicted component (and others not illustrated) may be combined or distributed across any number of components. Further, although depicted as software residing in memory 610, in some embodiments, the operations of the depicted components (and others not illustrated) may be implemented using hardware, software, or a combination of hardware and software.

In one embodiment, the system monitoring component 650 may monitor the system's operational status and collect relevant data, including, but not limited to, CPU usage, memory usage, I/O operations, network traffic, and system logs. The component 650 then provides the collected data to the failure prediction engine 655 for further processing and analysis. In some embodiments, before sending the data, the component 650 may preprocess the data, making it more suitable for predictive analysis. For example, the component 650 may parse through the data to filter out noise (e.g., outliers, missing values), normalize numerical input data to ensure consistency across different metrics, and/or combine certain data points to highlight trends or patterns.

In one embodiment, the failure prediction engine 655 may be configured to predict potential system failures or errors by analyzing the data collected by the system monitoring component 650. In some embodiments, the failure may include a system crash, an outage, a significant degradation of performance, or other incidents that disrupt the normal operations of a computing system. In some embodiments, the engine 655 may utilize statistical models or ML techniques to interpret the data and identify patterns or anomalies that deviate from established normal operations. The engine 655 may then assess the likelihood of a potential system failure or error based on the detected patterns or anomalies. In some embodiments, the engine 655 may assign a confidence score for each prediction. The score may reflect the engine's assessment of how likely it is that the detected condition will lead to a failure. The confidence score may help the PMM component 660 to prioritize actions based on the urgency and/or potential impact of the predicted failure.

In one embodiment, the PMM component 660 may be activated upon receiving a prediction of a potential failure from the prediction engine 655. The PMM component 660, once activated, may initiate processes like quiescing workloads, disabling paging, and other actions to stabilize the system and prepare for a clean state capture. Following that, the PMM component 660 may then execute a memory dump process to capture the system's state from the time of receiving the prediction to the time of the expected failure. In some embodiments, the PMM component 660 may search for backup resources and, if available, manage to shift normal operations to the backup resources to prevent service disruption.

In the illustrated example, the storage 615 may include system log(s) 670 (including detailed records of system operations, events, errors, and transactions), prediction record(s) 675, (including the data used to make the prediction, the outcome of the prediction, and any follow-up actions taken), and memory capture data 680 (including all relevant information about the system state from the time a prediction is received to the time the failure occurs. In some embodiments, the aforementioned information may be saved in a remote database (e.g., 270 of FIG. 2) that connects to the computing device 600 via a network.

In the preceding, reference is made to embodiments presented in this disclosure. However, the scope of the present disclosure is not limited to specific described embodiments. Instead, any combination of the features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages discussed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

While the foregoing is directed to embodiments of the present disclosure, other and further embodiments of the disclosure may be devised without departing from the basic scope thereof, and the scope thereof is determined by the claims that follow.

What is claimed is:

1. A method comprising:
receiving a prediction indicating that a failure within a computing system is predicted to occur at an anticipated time;
assessing one or more existing processes over a time window to identify data for preservation, wherein the time window begins at the reception of the prediction and extends to the anticipated time of the failure;
quiescing one or more workloads of the computing system based on the assessment;
initiating a memory dump process to save data in memory of the computing system; and
searching backup resources to expedite the memory dump process.

2. The method of claim 1, further comprising:
disabling paging of the one or more existing processes; and
allowing paging of one or more new processes that are initiated after the reception of the prediction.

3. The method of claim 1, wherein the failure within the computing system comprises at least one of a system crash, an outage, or a performance degradation.

4. The method of claim 1, wherein the data saved during the memory dump process captures a state of the one or more existing processes at the anticipated time.

5. The method of claim 1, further comprising organizing the data saved during the memory dump process into structured documentation for debug analysis.

6. The method of claim 1, wherein searching the backup resources comprises performing a system topology scan of the computing system to identify the backup resources.

7. The method of claim 1, wherein searching the backup resources comprises examining a defined policy that specifies the backup resources to be used in response to the failure.

8. The method of claim 1, further comprising:
upon determining that the backup resources are available for use, provisioning the backup resources to maintain normal operations of the computing system; and
conducting the memory dump process on primary resources of the computing system.

9. The method of claim 1, further comprising, upon determining that unused memory within the backup resources is available for use, allocating the unused memory from the backup resources for one or more new processes that are initiated after the reception of the prediction.

10. The method of claim 1, further comprising:
upon determining that the backup resources have already been provisioned, performing a failover operation that moves normal operations of the computing system to a disaster recovery site; and
conducting the memory dump process upon completion of the failover.

11. A system, comprising:
one or more computer processors; and
one or more memories collectively containing one or more programs, which, when executed by the one or more computer processors, perform operations, the operations comprising:
receiving a prediction indicating that a failure within a computing system is predicted to occur at an anticipated time;
assessing one or more existing processes over a time window to identify data for preservation, wherein the time window begins at the reception of the prediction and extends to the anticipated time of the failure;
quiescing workloads of the computing system based on the assessment;
initiating a memory dump process to save data in memory of the computing system; and
searching backup resources to expedite the memory dump process.

12. The system of claim 11, wherein the one or more programs, which, when executed by the one or more computer processors, perform the operations further comprising:
disabling paging of the one or more existing processes; and
allowing paging of one or more new processes that are initiated after the reception of the prediction.

13. The system of claim 11, wherein the failure within the computing system comprises at least one of a system crash, an outage, or a performance degradation.

14. The system of claim 11, wherein the data saved during the memory dump process captures a state of the one or more existing processes at the anticipated time.

15. The system of claim 11, wherein the one or more programs, which, when executed by the one or more computer processors, perform the operations further comprising organizing the data saved during the memory dump process into structured documentation for debug analysis.

16. The system of claim 11, wherein, to search backup resources to expedite the memory dump process, the one or more programs, which, when executed by the one or more computer processors, perform the operations comprising performing a system topology scan of the computing system to identify the backup resources.

17. The system of claim 11, wherein the one or more programs, which, when executed by the one or more computer processors, perform the operations further comprising:
upon determining that the backup resources are available for use, provisioning the backup resources to maintain normal operations of the computing system; and
conducting the memory dump process on primary resources of the computing system.

18. The system of claim 11, wherein the one or more programs, which, when executed by the one or more computer processors, perform the operations further comprising, upon determining that unused memory within the backup resources is available for use, allocating the unused memory from the backup resources for one or more new processes that are initiated after the reception of the prediction.

19. The system of claim 11, wherein the one or more programs, which, when executed by the one or more computer processors, perform the operations further comprising:
upon determining that the backup resources have already been provisioned, performing a failover operation that moves normal operations of the computing system to a disaster recovery site; and
conducting the memory dump process upon completion of the failover.

20. One or more non-transitory computer-readable media containing, in any combination, computer program code, which, when executed by a computer system, performs operations comprising:
receiving a prediction indicating that a failure within a computing system is predicted to occur at an anticipated time;
assessing one or more existing processes over a time window to identify data for preservation, wherein the time window begins at the reception of the prediction and extends to the anticipated time of the failure;
quiescing workloads of the computing system based on the assessment;
initiating a memory dump process to save data in memory of the computing system; and
searching backup resources to expedite the memory dump process.
